(19) United States
(12) Patent Application Publication
(10) Pub. No.: US 2011/0259459 A1
(43) Pub. Date: Oct. 27, 2011

(54) Turbo saver

(76) Inventor: Al W. Ongenae, Lac Du Bonnet (CA)

(21) Appl. No.: 12/932,576

(22) Filed: May 2, 2011

(30) Foreign Application Priority Data
Jul. 27, 2007 (CA) 2,593,393

(51) Int. Cl. F16L 55/10

(52) U.S. Cl. 138/89

(57) ABSTRACT

The turbosaver is inserted into The exhaust of an engine with A turbo to prevent the turbo From free spinning with no Lubrication while being Transported with the Engine in the off position

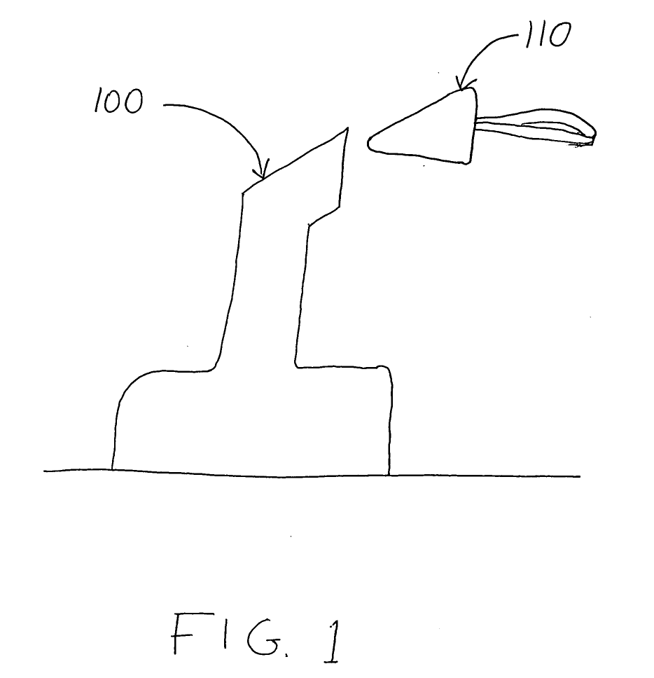

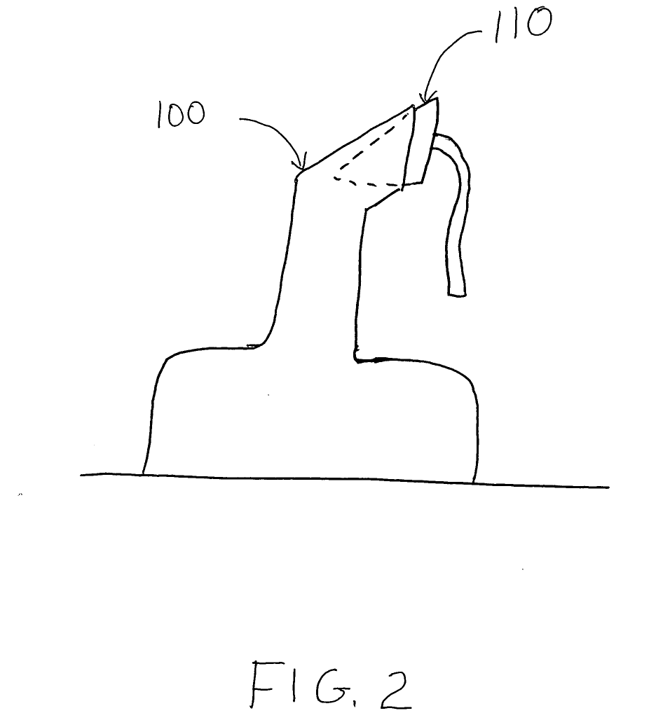

Insert foam plug into Exhaust opening when transporting Heavy equipment on lowbed Or float trailer,

this will Prevent the turbo from free Spinning by vacume or Pressure with no oil Lubrication when being Transported, strap will prevent The turbosaver from being lost In transport, and will blow out If forgotten by operator.

What is claimed is:

1. A foam plug in the exaust pipe will Prevent air movement that will Free spin a turbo into a dry turbo Bearing, resulting in premature Bearing failure.
